(19) United States
(12) Patent Application Publication
(10) Pub. No.: US 2024/0166085 A1
(43) Pub. Date: May 23, 2024

(54) Server and Lease Fee Calculation Method

(71) Applicant: TOYOTA JIDOSHA KABUSHIKI KAISHA, Toyota-shi, Aichi-ken (JP)

(72) Inventors: Yasuhide KURIMOTO, Kasugai-shi (JP); Tomoyoshi UEKI, Toyota-shi (JP); Yuko TERASAWA, Meguro-ku (JP); Masahiro KAGAMI, Nagoya-shi (JP); Hiroshi YAMASAKI, Nagoya-shi (JP); Kenji ZAITSU, Nisshin-shi (JP); Yoshihiko ENDO, Minato-ku (JP)

(21) Appl. No.: 18/501,097

(22) Filed: Nov. 3, 2023

(30) Foreign Application Priority Data
Nov. 22, 2022 (JP) 2022-186642

(51) Int. Cl. B60L 58/16; B60L 58/12

(52) U.S. Cl. CPC B60L 58/16; B60L 58/12

(57) ABSTRACT

A server includes: a communication unit (acquisition unit) that acquires information about a degree of degradation of a battery (secondary battery); and a processor (control unit) that calculates a lease fee of the battery using the information about the degree of degradation of the battery. The processor performs suppression processing for suppressing an increase of the lease fee, the increase of the lease fee being based on deterioration of a degree of discharging-caused degradation caused by discharging in response to a request for adjusting a power demand/supply state in a power system (PG).

This nonprovisional application is based on Japanese Patent Application No. 2022-186642 filed on Nov. 22, 2022 with the Japan Patent Office, the entire contents of which are hereby incorporated by reference.

### BACKGROUND

### Field

The present disclosure relates to a server and a lease fee calculation method.

### Description of the Background Art

Japanese Patent Application Laid-Open No. 2018-029430 discloses that a data center receives information about a secondary battery from an electrically powered vehicle and calculates a degree of degradation of the secondary battery.

### SUMMARY

When the electrically powered vehicle or the secondary battery is a leased one, the lease fee is set based on the degree of degradation of the secondary battery. Further, the secondary battery is degraded due to discharging. Here, when the secondary battery is discharged in response to a request for adjusting the power demand/supply state in a power system, the lease fee may be increased despite the contribution of the user of the electrically powered vehicle to society. Therefore, it has been desired to suppress the lease fee from being increased when the secondary battery is deteriorated due to the secondary battery being discharged in response to the request for adjusting the power demand/supply state.

The present disclosure has been made to the above-described problem and has an object to provide a server and a lease fee calculation method so as to suppress a lease fee from being increased when a secondary battery is degraded due to the secondary battery being discharged in response to a request for adjusting a power demand/supply state.

A server according to a first aspect of the present disclosure is a server that calculates a lease fee of an electrically powered vehicle or a secondary battery of the electrically powered vehicle, the server including: an acquisition unit that acquires information about a degree of degradation of the secondary battery; and a control unit that calculates the lease fee using the information about the degree of degradation. The control unit performs suppression processing for suppressing an increase of the lease fee, the increase of the lease fee being based on deterioration of a degree of discharging-caused degradation caused by discharging in response to a request for adjusting a power demand/supply state in a power system. It should be noted that the suppression of the increase of the lease fee includes not only reducing the increase of the lease fee but also causing the increase of the lease fee to be 0.

In the server according to the first aspect of the present disclosure, as described above, the suppression processing is performed to suppress the increase of the lease fee, the increase of the lease fee being based on the deterioration of the discharging-caused degradation degree. Thus, the lease fee can be suppressed by the suppression processing from being increased when the secondary battery is degraded due to the discharging in response to the request for adjusting the power demand/supply state in the power system.

In the server according to the first aspect, preferably, the control unit calculates the lease fee based on a difference between a total amount of the degree of degradation of the secondary battery and the degree of discharging-caused degradation. By configuring in this way, the lease fee can be calculated based on the value obtained by subtracting the degree of discharging-caused degradation from the total amount of the degree of degradation of the secondary battery. As a result, the increase of the lease fee based on the deterioration of the degree of discharging-caused degradation can be 0.

The server according to the first aspect preferably further includes an arithmetic expression storage unit that stores an arithmetic expression for calculating the degree of degradation of the secondary battery based on a condition for executing the discharging. The control unit calculates the degree of discharging-caused degradation using the arithmetic expression. By configuring in this way, the degree of discharging-caused degradation can be relatively accurately calculated using the above-described arithmetic expression.

The server according to the first aspect preferably includes a table storage unit that stores a table indicating a relationship between a condition for executing the discharging and the degree of degradation of the secondary battery. The control unit derives the degree of discharging-caused degradation by referring to the table. By configuring in this way, a processing load of the control unit can be reduced as compared with a case where the degree of discharging-caused degradation is calculated by an arithmetic operation.

A lease fee calculation method according to a second aspect of the present disclosure is a lease fee calculation method for calculating a lease fee of an electrically powered vehicle or a secondary battery of the electrically powered vehicle, the lease fee calculation method including: acquiring information about a degree of degradation of the secondary battery; and calculating the lease fee using the information about the degree of degradation. The calculating includes performing suppression processing for suppressing an increase of the lease fee, the increase of the lease fee being based on deterioration of a degree of discharging-caused degradation caused by discharging in response to a request for adjusting a power demand/supply state in a power system.

In the lease fee calculation method according to the second aspect of the present disclosure, as described above, the suppression processing is performed to suppress the increase of the lease fee, the increase of the lease fee being based on deterioration of the degree of discharging-caused degradation caused by the discharging in response to the request for adjusting the power demand/supply state in the power system. Thus, it is possible to provide a lease fee calculation method so as to suppress, by the suppression processing, the lease fee from being increased when the secondary battery is degraded due to the discharging in response to the request for adjusting the power demand/supply state in the power system.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a configuration of a system according to a first embodiment.

FIG. 2 is a diagram showing a degree of battery degradation due to discharge to a power system.

FIG. 3 is a diagram showing sequence control of the system according to the first embodiment.

FIG. 4 is a diagram showing a configuration of a system according to a second embodiment.

FIG. 5 is a diagram showing a table stored in a memory of the server according to the second embodiment.

FIG. 6 is a diagram showing sequence control of the system according to the second embodiment.

### DESCRIPTION OF THE PREFERRED EMBODIMENTS

### First Embodiment

Hereinafter, a first embodiment of the present disclosure will be described in detail with reference to the drawings. In the drawings, the same or corresponding parts are denoted by the same reference numerals, and the description thereof will not be repeated.

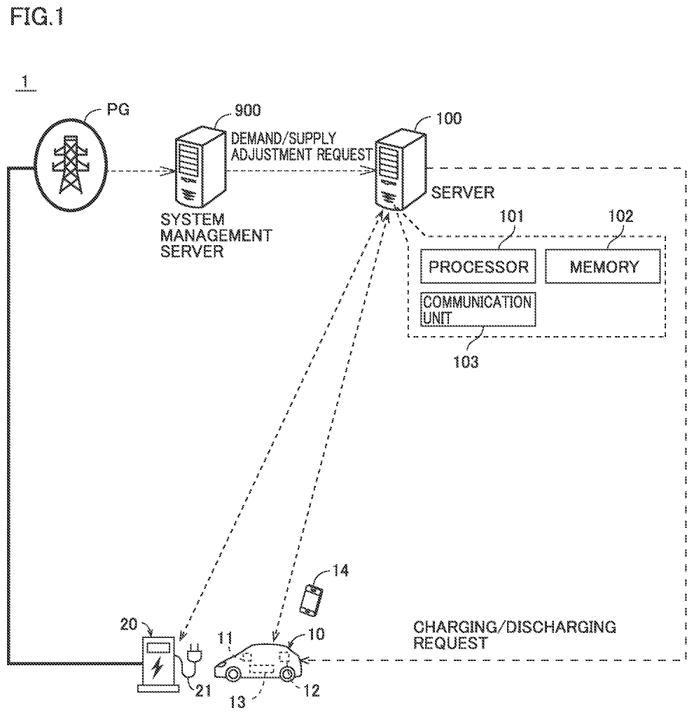

FIG. 1 is a diagram showing a configuration of a system 1 according to a first embodiment. The system 1 includes a server 100, a system management server 900, a power system PG, an electrically powered vehicle 10, and EVSE (Electric Vehicle Supply Equipment) 20.

The electrically powered vehicle 10 includes, for example, PHEV(Plug-in Hybrid Electric Vehicle), BEV (Battery Electric Vehicle), and FCEV(Fuel Cell Electric Vehicle).

The electrically powered vehicle 10 includes a car navigation system 11 and a communication device 12. The electrically powered vehicle 10 includes a battery (secondary battery) 13 that supplies electric power to electric equipment such as the car navigation system 11 and the communication device 12. The communication device 12 may include DCM (Data Communication Module). The communication device 12 may include a 5G (fifth generation mobile communication system) compatible communication I/F.

The EVSE 20 is configured to be electrically connected to the electrically powered vehicle 10. By connecting the charging cable 21 connected to the EVSE 20 to the inlet of the electrically powered vehicle 10, the battery 13 of the electrically powered vehicle 10 can be charged and discharged from the battery 13.

The power system PG is a power network constructed by a power plant and a power transmission and distribution facility (not shown). In this embodiment, the power company serves as both the power generation company and the power transmission and distribution company. The power company corresponds to a general power supply and distribution provider, and maintains and manages the power system PG. The power company corresponds to an administrator of the power system PG.

The system management server 900 manages power supply and demand in the power system PG (power network). The system management server 900 belongs to a power company. The system management server 900 transmits a request (demand/supply adjustment request) for adjusting the power demand amount of the power system PG to the server 100 based on the generated power and power consumption by each power adjustment resource managed by the system management server 900. Specifically, when the generated power of the power adjustment resource is expected to be higher than that of the normal state (or when the generated power of the power adjustment resource is currently higher), the system management server 900 transmits a request for increasing the power demand amount than that of the normal state to the server 100. Further, when the power consumption of the power adjustment resource is expected to be larger than that in the normal state (or when the power consumption of the power adjustment resource is currently larger), the system management server 900 transmits a request for reducing the power demand amount than in the normal state to the server 100.

The server 100 is a server managed by an aggregator. The aggregator is an electric provider that bundling a plurality of power adjustment resources such as a region and a predetermined facility to provide an energy management service.

The server 100 requests the electrically powered vehicle 10 to discharge (external discharge) to the power system PG and charge (external charge) from the power system PG as one means for increasing or decreasing the power demand of the power system PG. The server 100 transmits a request signal requesting external discharge or external charge to the electrically powered vehicle 10 or the mobile terminal 14 possessed by the user of the electrically powered vehicle 10.

The server 100 is configured to manage information of the registered electrically powered vehicle 10 (hereinafter also referred to as “vehicle information”), information of the registered user (hereinafter also referred to as “user information”), and information of the registered EVSE 20 (hereinafter also referred to as “EVSE information”). The user information, the vehicle information, and the EVSE information are distinguished by identification information (ID) and stored in a memory (calculation formula storage unit) 102 described later.

The user ID is identification information for identifying a user. The user ID also functions as information (terminal ID) for identifying the mobile terminal 14 carried by the user. The server 100 is configured to store information received from the mobile terminal 14 separately for each user ID. The user information includes a communication address of the mobile terminal 14 carried by the user and a vehicle ID of the electrically powered vehicle 10 belonging to the user.

The vehicle ID is identification information for identifying the electrically powered vehicle 10. The vehicle ID may be a number plate. The vehicle ID may be VIN(Vehicle Identification Number). The vehicle information includes an action schedule of the electrically powered vehicle 10.

The EVSE-ID is identification information for identifying the EVSE 20. The EVSE information includes a communication address of the EVSE 20 and a state of the electrically powered vehicle 10 connected to the EVSE 20. The EVSE information includes information indicating a combination of the electrically powered vehicle 10 and the EVSE 20 connected to each other (for example, a combination of the EVSE-ID and the vehicle ID).

The server 100 includes a processor (control unit) 101, a memory 102, and a communication unit (acquisition unit) 103. The processor 101 and the communication unit 103 are examples of the “control unit” and the “acquisition unit” of the present disclosure, respectively. The memory 102 is an example of the “calculation formula storage unit” of the present disclosure.

The processor 101 calculates the lease fee of the battery 13 using information on the degree of degradation of the battery 13. For example, the processor 101 calculates the lease fee of the battery 13 based on the difference between the capacity retention of the battery 13 before the lease of the battery 13 and the capacity retention of the battery 13 after the lease of the battery 13. As information on the degree of degradation of the battery 13, information on the degree of degradation (100-capacity retention [%]) of the battery 13 may be used.

The memory 102 stores, in addition to a program executed by the processor 101, information (e.g., map, formula, and various parameters) used by the program. The communication unit 103 includes various communication I/Fs. The processor 101 controls the communication unit 103. Specifically, the processor 101 communicates with the system management server 900, the communication device 12 of the electrically powered vehicle 10 (or the mobile terminal 14 of the user of the electrically powered vehicle 10), and the EVSE 20 through the communication unit 103.

The communication unit 103 acquires information on charging and discharging by the electrically powered vehicle 10. Specifically, the communication unit 103 acquires information such as a charge/discharge amount, a charge/discharge time, and a time period during which the electrically powered vehicle 10 is charged/discharged between the electrically powered vehicle 10 and the EVSE 20.

Here, in the conventional system, when the discharge (external discharge) of the battery 13 is performed in response to a request for adjusting the power demand/supply state in the power system PG, the lease fee of the battery 13 may be increased although the user of the electrically powered vehicle 10 contributes to society. Therefore, it is desirable to suppress an increase in the lease fee of the battery 13 when the battery 13 deteriorates due to discharge of the battery 13 in response to a request for adjusting the power demand/supply state.

Therefore, in the first embodiment, the processor 101 performs suppression processing for suppressing an increase in lease fee based on deterioration of the degree of deterioration caused by discharge. The degree of deterioration caused by the discharge is a degree of deterioration caused by the discharge in response to a request for adjusting the power demand/supply state in the power system PG. A specific description will be given below.

The communication unit 103 acquires information on the degree of degradation of the battery 13. Specifically, the communication unit 103 acquires the OCV (Open Circuit Voltage) of the battery 13 at the start of discharging, the OCV of the battery 13 at the end of discharging, and the discharge current amount ΔAh of the battery 13 between the start and the end of discharging from the electrically powered vehicle 10. In consideration of the influence of polarization, it is preferable that the time of the end of the discharge be a time point at which about 30 minutes have elapsed from the time of the actual end of the discharge.

The processor 101 converts the difference between the OCV at the start of discharging and the OCV at the end of discharging into the SOC difference ΔSOC by referring to the SOC-OCV curve stored in the memory 102 in advance. Then, the processor 101 calculates the full charge capacity C of the battery 13 according to the following equation (1) in which the ratio of the discharge current amount ΔAh to the SOC difference ΔSOC is equal to the ratio of the full charge capacity C to the SOC difference of 100%. Since the full charge capacity C0 in the initial state is known from the specification of the battery 13, the capacity retention Q can be calculated from the full charge capacity C (Q=C/C0). The following expression (1) is stored in the memory 102. The following expression (1) is an example of the “arithmetic expression” of the present disclosure.

C=ΔAh/ΔSOC×100 (1)

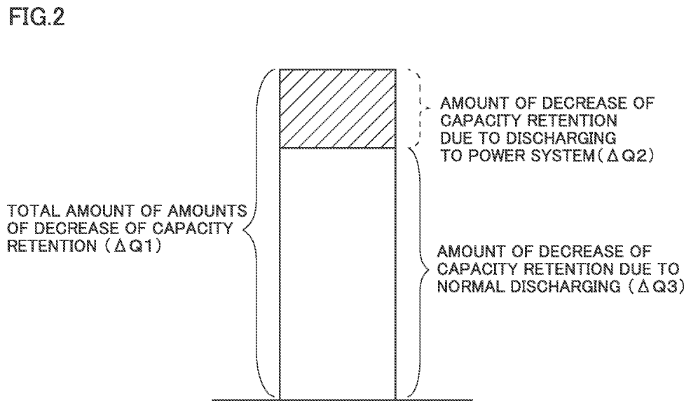

The processor 101 stores information on the decrease amount ΔQ of the capacity retention Q caused by the discharge to the power system PG in the memory 102 every time the discharge is performed. As a result, as shown in FIG. 2, the total amount (ΔQ1) of the decrease amount of the capacity retention of the battery 13 is distinguished into the decrease amount (ΔQ2) of the capacity retention due to the discharge to the power system PG and the decrease amount (ΔQ3) of the capacity retention due to the normal discharge other than the above. The decrease amount (ΔQ2) of the capacity retention due to the discharge to the power system PG is an example of the “discharging-caused degradation degree” of the present disclosure.

Specifically, the processor 101 calculates the lease fee of the battery 13 based on the difference (ΔQ1−ΔQ2=ΔQ3) between the total amount (ΔQ1) of the decrease in the capacity retention and the decrease in the capacity retention due to the discharge to the power system PG. A table indicating the relationship between the decrease amount of the capacity retention and the lease fee may be stored in the memory 102.

Further, the degree of degradation due to the charge of the battery 13 (the amount of decrease in the capacity retention) may be taken into consideration. Specifically, the amount of decrease in the capacity retention due to the charge may be calculated using the equation for calculating the capacity retention due to the charge corresponding to the equation (1). Then, the lease fee may be calculated based on the difference between the total amount of decrease in the capacity retention due to charging and discharging and the amount of decrease in the capacity retention due to discharging to the power system PG. Alternatively, the lease fee may be calculated based on the difference between the total amount of decrease in the capacity retention due to charging and discharging and the total amount of decrease in the capacity retention due to discharging to the power system PG and charging from the power system PG.

(Lease Price Method)

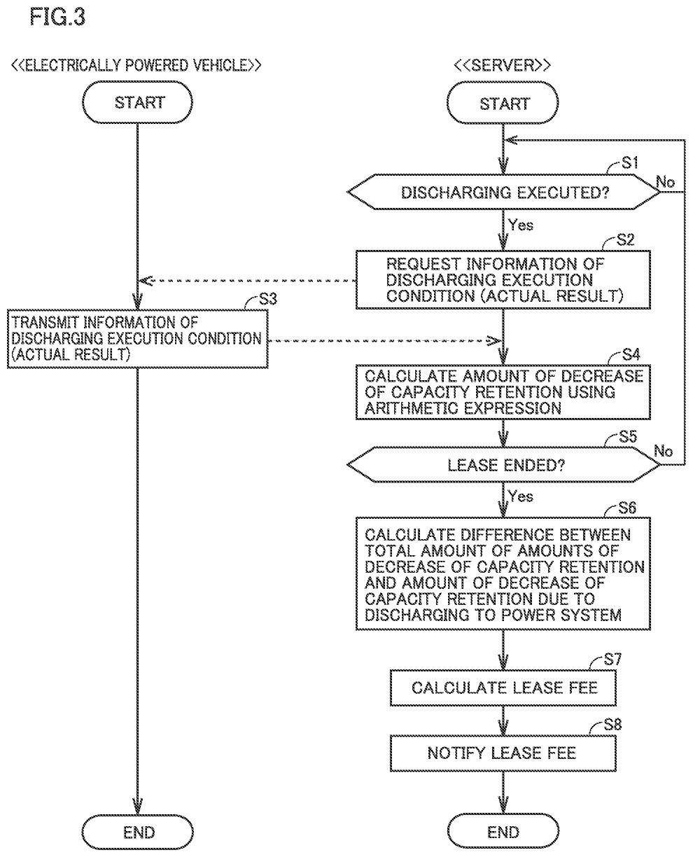

A method of calculating the lease fee of the battery 13 by the server 100 will be described with reference to the sequence diagram of FIG. 3.

In step S1, the processor 101 determines whether or not discharge by the electrically powered vehicle 10 has been executed. Specifically, the processor 101 may make the determination in accordance with a signal transmitted from the electrically powered vehicle 10 or the EVSE 20 to the server 100 when discharging by the electrically powered vehicle 10 is performed. When the electric discharge by the electrically powered vehicle 10 is executed (Yes in S1), the process proceeds to step S2. When discharge by the electrically powered vehicle 10 is not performed (No in S1), the process of step S1 is repeated.

In step S2, the processor 101 requests information on the execution condition (actual result) of the discharge executed in step S1 through the communication unit 103. Specifically, as described above, the processor 101 acquires the OCV of the battery 13 at each of the start time and the end time of the discharge, and the discharge current amount ΔAh of the battery 13 between the start time and the end time of the discharge.

In step S3, in response to the request in step S2, the electrically powered vehicle 10 transmits, to the server 100, information on a discharging execution condition (actual result).

In step S4, the processor 101 calculates the amount of decrease in the capacity retention of the battery 13 using the information acquired in step S3 and the above-mentioned equation (1). At this time, the processor 101 can determine whether or not discharge to the power system PG has been executed based on presence or absence of a demand/supply adjustment request from the system management server 100. Based on this determination, the processor 101 stores the total amount (ΔQ1) of the decrease amount of the capacity retention due to the discharge of the battery 13 and the decrease amount (ΔQ2) of the capacity retention due to the discharge to the power system PG in the memory 102 separately from the normal discharge other than the above.

In step S5, the processor 101 determines whether or not the lease period of the battery 13 has ended. For example, the processor 101 may perform the determination in response to detecting that a preset lease period has elapsed. Further, the processor 101 may execute the above determination in response to reception of a command signal for calculating a lease fee from the electrically powered vehicle 10 or the like. When the lease period ends (Yes in step S5), the process proceeds to step S6. When the lease period has not ended, the process returns to step S1.

In step S6, the processor 101 calculates a difference (ΔQ1−ΔQ2=ΔQ3) between the total amount (ΔQ1) of the decrease amount of the capacity retention of the battery 13 calculated in step S4 and the decrease amount (ΔQ2) of the capacity retention due to the discharge to the power system PG.

In step S7, the processor 101 calculates a lease fee based on the difference calculated in step S6. For example, the processor 101 may calculate the lease fee by referring to a table stored in the memory 102 and indicating the relationship between the decrease amount of the capacity retention and the lease fee. That is, the processor 101 calculates the lease fee in a state in which the influence of the degree of degradation of the battery 13 due to the discharge to the power system PG on the lease fee is set to 0.

In step S8, the processor 101 transmits the lease fee calculated in step S7 to the electrically powered vehicle 10 or the mobile terminal 14 through the communication unit 103.

As described above, in the first embodiment, the processor 101 performs suppression processing for suppressing an increase in lease fee based on deterioration (increase) of the degree of discharging-caused degradation (ΔQ2) caused by discharge in response to a request for adjusting the power demand/supply state in the power system PG. Thereby, the degree of degradation of the battery 13 due to the discharge to the power system PG can be suppressed from being reflected in the lease fee.

### Second Embodiment

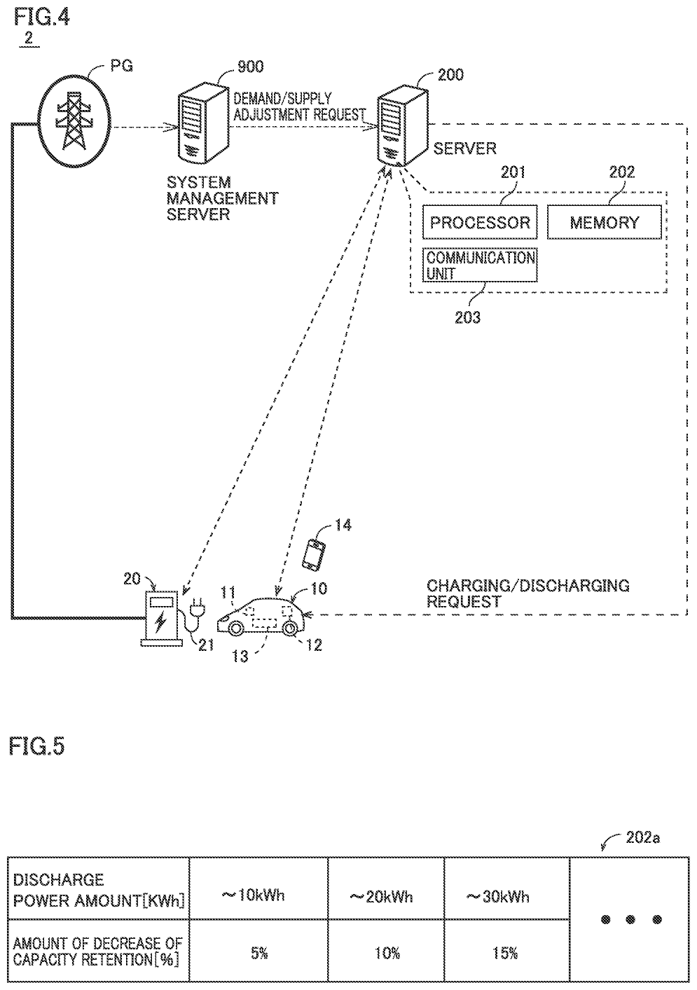

Next, the server 200 and the system 2 according to the second embodiment will be described with reference to FIGS. 4 to 6. In the second embodiment, unlike the first embodiment in which the degree of degradation of the battery 13 due to discharge to the power system PG (the amount of decrease in the capacity retention) is calculated by calculation, the amount of decrease in the capacity retention is not calculated by calculation. The same components as those in the first embodiment are denoted by the same reference numerals as those in the first embodiment, and a repetitive description thereof will not be given.

FIG. 4 is a diagram showing a configuration of a system 2 according to a second embodiment. The system 2 includes a server 200, a system management server 900, a power system PG, an electrically powered vehicle 10, and an EVSE 20.

The server 200 includes a processor (control unit) 201, a memory (table storage unit) 202, and a communication unit (acquisition unit) 203. The processor 201 and the communication unit 203 are examples of the “control unit” and the “acquisition unit” of the present disclosure. The memory 202 is an example of the “table storage unit” of the present disclosure.

The memory 202 stores a table 202a (see FIG. 5) indicating the relationship between the execution conditions of the discharge and the amount of decrease in the capacity retention caused by the discharge of the battery 13. Specifically, the table 202a shows the relationship between the discharge power amount from the electrically powered vehicle 10 and the decrease amount of the capacity retention.

The processor 201 derives the amount of decrease in the capacity retention due to the discharge based on the information on the amount of electric power discharged from the electrically powered vehicle 10. For example, when the total amount of discharge power is 28 KWh, it is assumed that the capacity retention is reduced by 15%. When the discharge power amount in discharging to the power system PG is 15 KWh, it is presumed that the capacity retention is reduced by 10%. The table 202a shown in FIG. 5 is merely an example, and is not limited to the example shown in FIG. 5. Further, a table in which information (e.g., discharge time) other than the discharge power amount is taken into consideration may be used.

(Lease Price Method)

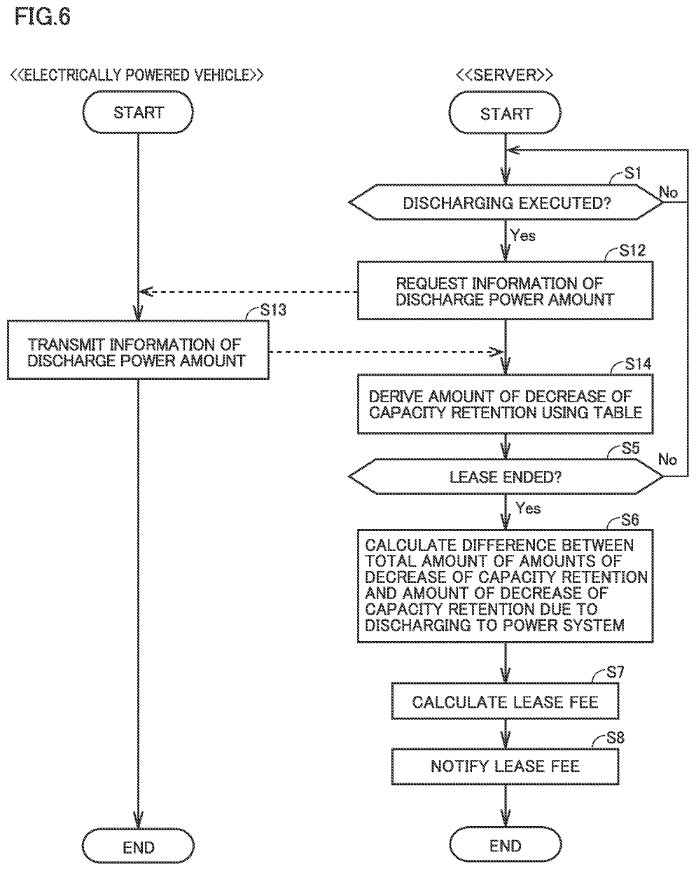

A method of calculating the lease fee of the battery 13 by the server 200 will be described with reference to the sequence diagram of FIG. 6. Note that the same processes as those in the first embodiment are denoted by the same reference numerals, and a repetitive description thereof will not be given.

If YES in step S1, the process of step S12 is performed. In step S12, the processor 201 requests information on the execution condition (actual result) of the discharge executed by the electrically powered vehicle 10 through the communication unit 203. Specifically, the processor 201 acquires information on the amount of electric power discharged by the electrically powered vehicle 10.

In step S13, in response to the request in step S12, the electrically powered vehicle 10 transmits the information of the discharge power amount to the server 100.

In step S14, the processor 201 calculates the amount of decrease in the capacity retention of the battery 13 using the information acquired in step S13. Specifically, the processor 201 uses the information acquired in step S13 and the table 202a stored in the memory 102 to derive the amount of decrease in the capacity retention of the battery 13. The subsequent processes in step S5 and subsequent steps are similar to those in the first embodiment.

Other configurations of the second embodiment are similar to those of the first embodiment, and therefore, repetitive description thereof will not be given.

In the above-described first and second embodiments, the lease fee is calculated with the influence on the lease fee of the degree of degradation of the battery 13 due to the discharge to the power system PG (the amount of decrease in the capacity retention) set to 0, but the present disclosure is not limited thereto. The lease fee may be calculated in a state where the influence of the degree of degradation of the battery 13 caused by the discharge to the power system PG on the lease fee is reduced to a predetermined value larger than 0.

Although the server 100 calculates the capacity retention of the battery 13 in the first embodiment, the present disclosure is not limited thereto. An ECU (Electric Control Unit) of the electrically powered vehicle 10 may calculate the capacity retention and the decrease amount of the capacity retention. The table 202a in the second embodiment may be stored in the memory of the electrically powered vehicle 10.

In the first and second embodiments, the difference between the decrease amount (ΔQ1) of the capacity retention of the battery 13 and the decrease amount (ΔQ2) of the capacity retention due to the discharge to the power system PG is calculated. The processor 101 (201) may directly calculate a decrease amount (ΔQ3) of the capacity retention due to normal discharge other than discharge to the power system PG.

In the first and second embodiments, the battery 13 is leased. The electrically powered vehicle 10 may be leased.

The configurations (processing) of the above-described embodiments and the above-described modified examples may be combined with each other.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A server that calculates a lease fee of an electrically powered vehicle or a secondary battery of the electrically powered vehicle, the server comprising:
an acquisition unit that acquires information about a degree of degradation of the secondary battery; and
a control unit that calculates the lease fee using the information about the degree of degradation, wherein
the control unit performs suppression processing for suppressing an increase of the lease fee, the increase of the lease fee being based on deterioration of a degree of discharging-caused degradation caused by discharging in response to a request for adjusting a power demand/supply state in a power system.

2. The server according to claim 1, wherein the control unit calculates the lease fee based on a difference between a total amount of the degree of degradation of the secondary battery and the degree of discharging-caused degradation.

3. The server according to claim 1, further comprising an arithmetic expression storage unit that stores an arithmetic expression for calculating the degree of degradation of the secondary battery based on a condition for executing the discharging, wherein
the control unit calculates the degree of discharging-caused degradation using the arithmetic expression.

4. The server according to claim 1, further comprising a table storage unit that stores a table indicating a relationship between a condition for executing the discharging and the degree of degradation of the secondary battery, wherein
the control unit derives the degree of discharging-caused degradation by referring to the table.

5. A lease fee calculation method for calculating a lease fee of an electrically powered vehicle or a secondary battery of the electrically powered vehicle, the lease fee calculation method comprising:
acquiring information about a degree of degradation of the secondary battery; and
calculating the lease fee using the information about the degree of degradation, wherein
the calculating includes performing suppression processing for suppressing an increase of the lease fee, the increase of the lease fee being based on deterioration of a degree of discharging-caused degradation caused by discharging in response to a request for adjusting a power demand/supply state in a power system.
